(19) United States
(12) Patent Application Publication
(10) Pub. No.: US 2005/0223678 A1
(43) Pub. Date: Oct. 13, 2005

(54) Apparatus and method for production of inflated materials

(75) Inventor: Hasdi Matarasso, Netanya (IL)

Correspondence Address: DAVIDSON, DAVIDSON & KAPPEL, LLC, 485 SEVENTH AVENUE, 14TH FLOOR, NEW YORK, NY, 10018, US

(73) Assignee: Nova-Tek Technologies Ltd., Netanya (IL)

(21) Appl. No.: 10/516,718

(22) PCT Filed: Jun. 4, 2003
(86) PCT No.: PCT/IL03/00477

§ 371 Date: May 12, 2005

Related U.S. Application Data
(60) Provisional application No. 60/385,607, filed on Jun. 5, 2002.

(51) Int. Cl. B67B 3/24

(52) U.S. Cl. 53/403

(57) ABSTRACT

An apparatus and method for the production of inflated cellular cushioning material, the apparatus comprising a dispensing unit comprising a feeding material roll, for feeding plastic material having sleeves or rows of cells, to be filled with air and a first and second conveyors for receiving the feeding material and holding such feeding material in a substantially flat position between the first and second conveyors.

### PRIORITY APPLICATION

The present application claims priority from U.S. application 60/385,607 for “DEVICE AND METHOD FOR THE PRODUCTION OF CELLULAR CUSHIONED MATERIAL” filed on Jun. 5, 2002.

### BACKGROUND OF THE INVENTION

1. Field of the Invention

The present invention relates to an apparatus and method for production of materials, in general and to an apparatus and method for the production of inflated cellular materials, in particular.

2. Discussion of the Related Art

Inflated cellular materials are widely used for packaging, cushioning of various products, void filling as well as for other uses. Inflated cellular materials contain inflated areas, which may be called “bubbles” or “air bubbles”, juxtaposed to each other. Hence, an ideal inflated cellular material surrounding or wrapping an object can soften a blow from any source external to the object. Typical products that require cushioning are fragile products, such as glass and porcelain, and products that require special care while handling such as electronic apparatuses and the like. Thus, cushioning cellular materials prevent hitting and shocks that may occur to items during their handling in various circumstances such as transportation or elevation. Handling products while unprotected with inflated materials can seriously damage or incline defects to the functionality and esthetic appearance of the products. Naturally, different products with different characteristics regarding to their weight, size, sensitivity to mechanical shocks and the like require different types of inflated cellular materials for their protection. Consequently, there are different inflated cellular materials used and various types, sizes and shapes of air bubbles.

The production of inflated cellular materials requires various expertise skills. Among the skills required are the selection of suitable materials for inflating, assembling an apparatus for production of inflated cellular materials and other skills. U.S. application Ser. No. 09/758,544 titled CELLULAR CUSHIONING MATERIAL AND METHOD FOR ITS PRODUCTION, filed on Jan. 12, 2001 discloses a method for production of a cellular inflated material. However, this method does not disclose a method for a mass production of inflated material. Production of inflated material raises a problematic issue regarding the mass production that derives from the nature of inflating a material. Insertion of air into a material as performed during the production of inflated cellular material causes a deformation of the material and therefore the jamming of the production apparatus. Thus, the material prior to inflating of air is flat and after the inflation of air to the material has another dimension perpendicular to the surface of the material subject to the air inflated into the material. Moreover, in other occurrences the jamming of the material can result in halting of the production line until removal of obstacle. As a result the inflated cellular material received from production within the prior art is often deformed. This deformation of the material after the inflation causes severe production faults that limit the mass production of inflated cellular materials. Furthermore, the deformation of the inflated material becomes graver as the dimensions of the material surface are larger per time unit of production and as the single air bubble is larger. There is therefore a need for an apparatus for production of inflated cellular material that will not suffer from the defects described above. There is a further need to provide method that will provide production method that will not cause any deformation of the feeding material that fabricates the inflated cellular material.

The present invention disclosed overcomes faults that exist in the prior art. Thus providing an apparatus and method that enables a mass production of inflated cellular materials.

### SUMMARY OF THE PRESENT INVENTION

It is an object of the present invention to provide an apparatus for the manufacture of inflatable cushioning material, so as to avoid deformation in the process of production.

It is a further object of the present invention to provide an apparatus for the manufacture of inflatable cushioning material.

In accordance with one aspect of the present invention there is provided an apparatus for the production of inflated cellular cushioning material, the apparatus comprising a dispensing unit comprising a feeding material roll, for feeding plastic material having sleeves or rows of cells, to be filled with air; a first and second conveyors for receiving the feeding material and holding such feeding material in a substantially flat position confining feeding material inflation, between the first and second conveyors; a motor for rolling the first and second conveyors; a device for supplying air or gas for providing air or gas connected to an air pipe inflator for directing the flow of air or gas into the feeding material; and a welding unit for sealing the feeding material.

The first and second conveyors are used so as to control or limit the amount of air or gas inflated into the sleeves or rows of cells. The device for moving the conveyors such as a motor is used. The device for supplying air or gas is positioned so as to allow the inflation of the feeding materials. The device for supplying air or gas is a centrifugal blower.

The first conveyor is mechanically situated such that the feeding material is received by the first and second conveyors so that when the feeding material is inflated, said material comes in contact with the first and second conveyors. The first conveyor is positioned on one side of the feeding material while the second conveyor is positioned on the opposite side of the feeding material.

The welding unit is a heating bar unit controlled to reach high temperature in a predetermined time period allowing a short time interval contact with inflated feeding material. The welding unit welds a horizontal line across the span of the feeding material. The welding unit welds a short longitudinal line and a long horizontal line across the span of the feeding material.

The apparatus may further comprise a cutting machine comprising a bottom and top cutting members for cutting the inflated cellular cushioning material at the end of the production line. The length between each conveyor can be adjusted in the up and down direction so as to allow additional air to be inflated into the feeding material. The first conveyor may be opened for allowing an operator of the apparatus to feed the feeding material into the apparatus. The first and second conveyors comprise rollers placed within a metal frame coupled to free hinges allowing the free rotation of each roller; a belt placed around the rollers such that the belt may provide forward or backward movement of the conveyors belt.

The first and second conveyors are belt conveyors. The first and second conveyors are belt conveyors, each conveyor comprising a belt having a width sufficient to hold the position of the side edges of feeding material. The belt is a chain having a plurality of plastic units of fixed length. The belt can be made of a flexible material.

The apparatus may further comprise a third and fourth conveyors for receiving the feeding material and holding such feeding material in a substantially flat position between the first and second conveyors. The conveyors can alternatively be rollers or plates.

In accordance with a second aspect of the present invention there is provided a method for the production of inflated cellular material, the method comprising the steps of feeding pre-welded feeding material to the apparatus; conveying the feeding material in the opposite direction to the direction of the air flow from an air pipe inflator; controlling the amount of air inserted into the feeding material through the use of a first and second conveyors; applying a welding unit to the inflated feeding material, thus forming inflated cellular cushioning material. The method further comprises the step of providing the ready to use inflated cellular material at the end of the production process.

### BRIEF DESCRIPTION OF THE DRAWINGS

The present invention will be understood and appreciated more fully from the following detailed description taken in conjunction with the drawings in which:

FIG. 1 is a schematic illustration of an apparatus for production of inflated cellular materials according to prior art;

FIG. 2 is a schematic illustration of the preferred embodiment of an apparatus according to the present invention;

FIG. 3 is a side view schematic illustration of the preferred embodiment of an apparatus according to the present invention;

FIG. 4 is a schematic illustration of a second preferred embodiment of an apparatus according to the present invention;

FIG. 5 is a schematic illustration of a third preferred embodiment of an apparatus according to the present invention;

FIG. 6 is a schematic illustration of a fourth preferred embodiment of an apparatus according to the present invention;

FIG. 7 is a schematic illustration of a fifth preferred embodiment of an apparatus according to the present invention;

### DETAILED DESCRIPTION OF THE PREFERRED EMBODIMENT

The present invention overcomes disadvantages of the prior art by providing a novel apparatus and method that enables mass production of inflated cellular material. The present invention provides further an apparatus and method for production of inflated cellular material regardless of the size of the surface of the material to be inflated and regardless of the size and shape of the air bubbles of the inflated cellular material.

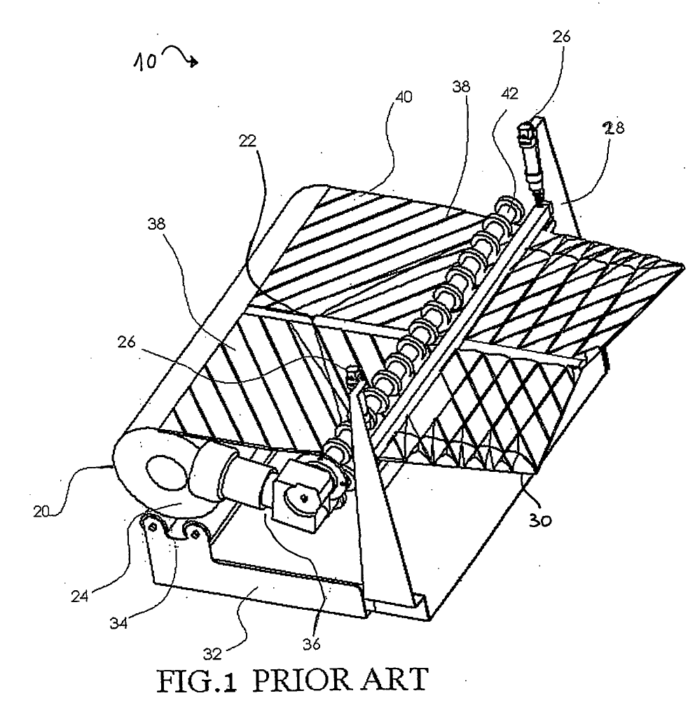

The advantages of the present invention will be appreciated in view of the following drawings. FIG. 1 present an apparatus 10 that is a typical apparatus used within the prior art for production of inflated cellular material. Apparatus 10 includes a housing 32 that includes a dispenser unit 34, a motor 36 and an air pipe inflator 22 connected to a blower (not shown). A roll of material 20 to be inflated is located on dispenser unit 34. The feeding material 40 from dispenser unit 34 advances towards welding unit 28 with the aid of advancing wheels 42. Advancing wheels 42 are all positioned on one pivot extending from motor 36. Advancing wheels 42 advances material 40 to welding unit 28 to receive inflated cellular material 30. Roll of material 20 consists of two layers that are pre-welded in a way that presents angled sleeves 38. Sleeves 38 are aligned towards air pipe inflator 22. Whilst the advancement of material 40 the air pipe inflator 22 inserts air to pre-welded sleeves 38 as well as cutting a path through material 40 with a knife (not shown) attached to air pipe inflator 22 structure. Apparatus 10 provides poor quality of inflated cellular material 30 when the inflated cellular material is produced as a mass production line because material 40 deforms from its initial feeding form after the insertion of air from air pipe inflator 22. Accordingly, subject to the inserted air to sleeves 38 material 40 the volume changes and the horizontal width of material 40 is reduced unevenly. The deformation causes the inflated cellular material 30 to be defected. The deformation of the feeding material 40 is caused directly from the insertion of an uncontrolled amount of air to said sleeves 38. The air pipe inflator 22 inflates air to material 40. The amount of air is inflated according to the velocity of convection of material 40 and the air pressure from air pipe inflator 22. However, the requirements of a consumer to receive an inflated cellular material 30 results with air bubbles that are full with air or gas and a deformed inflated cellular material 30 that is produced with defects. Thus, material 40 is deformed causing the welding process performed by the welding unit 28 to be inaccurate, the advancement of material 40 by advancing wheels 42 is disturbed, the inflated cellular material 30 is wavy and not uniform, low density of juxtaposed air bubbles within the material as well as other defects. Previous machines did not contemplate the possibility mass production of inflated cellular material in a compact size apparatus for a small business operation as well as a mass production line for big firms. The present invention provides an apparatus that provides a reliable apparatus that is able to produce uniform quality of inflated cellular material.

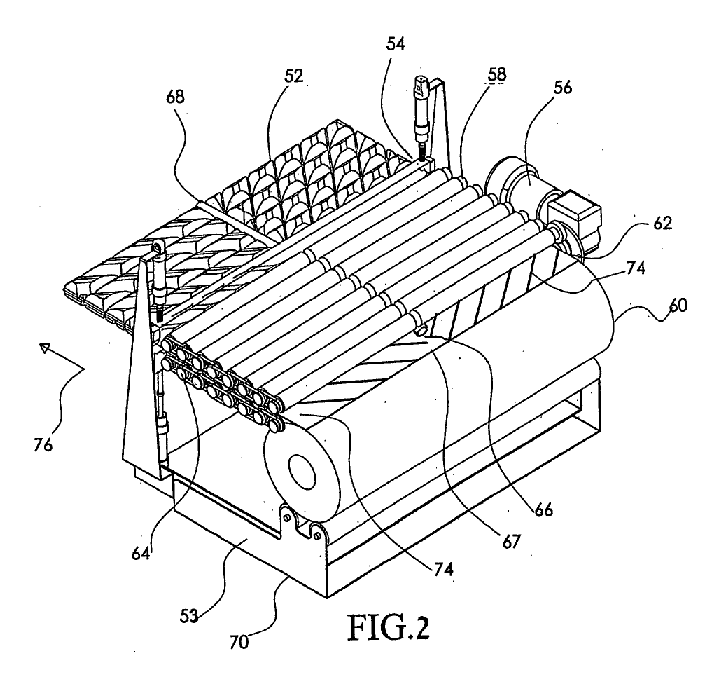

FIG. 2 presents one embodiment of an apparatus according to the present invention. The apparatus 50 comprises a housing 53 that comprises the dispensing unit 70, a first conveyor 58, a second conveyor 64, a welding unit 54, a motor 56, an air pipe inflator 66 and a blower (not shown). Feeding material roll 60 is positioned on dispensing unit 70 and provides the feeding material 62 to produce inflated cellular material 52. According to one embodiment of the invention feeding material 62 is conveyed from feeding material roll 60 by the second conveyor 64 towards the welding unit 54. The conveyors are comprised of plastic or metal. The cylinder roller conveyors having rollers are comprised of plastic or metal or a combination thereof. The direction of the movement is indicated by arrow 76. According to the preferred embodiment is opposed to the direction of the air outlet of air pipe inflator 66. According to one embodiment a knife (not shown) is attached to air pipe inflator 66. The knife tears the passage 67 set within the pre-welded feeding material for the inlet of air from air pipe inflator 66. The feeding material 62 is a plastic material such as polyethylene with thickness of about 30 Microns. Naturally, according to other embodiments other thickness of polyethylene and other materials can be used. The feeding material 62 is pre-welded in any manner known in the art, such as pre-fabricated metal molded forms that are heated to a sufficient heat and compressed against the flat (not welded) material to form sleeves or rows of cells 74. According to the present embodiment of the invention sleeves or rows of cells 74 of the feeding material 62 are inflated so that after the welding unit 54 performed the welding, the inflated cellular material 52 is created. The sleeves or rows of cells 74 according to the present embodiment of the present invention are angular or perpendicular to the air pipe inflator 66. Accordingly, sleeves or rows of cells 74 are positioned between 35-135° towards the air pipe inflator 66. The angular pre-welded sleeves or rows of cells 74 enable the sufficient air inflation from air pipe inflator 66. The distance between each wall of sleeves or rows of cells 74 as performed in the pre-welded step can be according to one embodiment 20-100 millimeters. According to the preferred embodiment the feeding material 62 is held flat down the first and second conveyors 58, 64. The first and second conveyors 58, 64 according to the present embodiment are set to control the amount of air inflated to sleeves or rows of cells 74. The careful control or limitation of the amount of air within sleeves or rows of cells 74 performed by the first and second conveyors 58, 64 prevents the creation of defects within feeding material 62, provides an efficient welding process and provides a un-defected inflated cellular material 52. The first and second conveyors 58, 64 operate as a sufficient air inflated controller within feeding material. The first and second conveyors 58, 64 are also used for other purposes as well such as assisting in conveying feeding material 62 and the like. To limit the amount of air that can be inflated into the feeding material when passed through the first and second conveyors 58, 64, a control unit (not shown) determines the distance between the two conveyors. In alternative embodiment the conveyors 58, 64 are mechanically situated such that the feeding material may be received by the conveyors but when inflated the feeding material comes in contact with the conveyors. As a result the amount of air within the feeding material will be limited and in addition the movement of the conveyors themselves will drive the inflated feeding material towards the welding unit. According to the present embodiment the first conveyor 58 and second conveyor 64 are activated by motor 56. Motor 56 can be an angular transmission motor with output capacity of 60-200 Watt that enables a velocity of 100-200 cycles per minute (CPM). The blower according to the embodiment shown in FIG. 2 is positioned below second conveyor 64 and therefore is not viewed in FIG. 2. However, according to other embodiments the blower can be positioned elsewhere. The blower can be a centrifugal blower having an output capacity of 30-100 Watt providing an air pressure output that ranges 40-200 mmH₂O. The air pipe inflator 66 is connected to blower and inflates air to feeding material 62. The first conveyor 58 is positioned in such a distance from the second conveyor 64 such that the amount of air within inflated feeding material 62 is controlled. The distance from the plastic roll to the conveyors is about 5 to 30 centimeter but can be shorter or longer. The distance between the conveyors is 1 millimeter to 30 millimeter but can be wider or narrower. The optimum air amount within feeding material 62 is sufficient for producing a top quality inflated cellular material 52 and concurrently preventing deformation of feeding material 62 at all steps of production. In addition, when inflated the feeding material 62 comes in contact with cylinder rolling conveyers. The movement of the cylinder rolling conveyers assists the advancement of the feeding material 62 along the production line. Though the preferred embodiment presented in FIG. 2 refers to one air pipe inflator 66 positioned in the center of conveying feeding material 62 one skilled in the art can appreciate that according to other embodiment of the present invention the air pipe inflator can be positioned otherwise in according to the conveyed feeding material 62 such as in the side of the said material. According to other embodiments it is contemplated that a number of air pipe inflators are present in a single apparatus. The inflated feeding material 62 is conveyed by the first and second conveyors 58, 64 to the welding unit 54. Welding unit 54 can be fast heating bar unit controlled to reach high temperature in a short time period and the ability to reach short time interval contact with inflated feeding material. Welding unit 54 welds horizontally to the movement of feeding material 62, thus, providing an inflated cellular material 52 complete and ready to use. The horizontal welding line can span substantially along the span of the feeding material or a part thereof. The welding unit may be adapted to also weld a short longitudinal line such as next to the air inlet line and in the length of a step of advancement of the feeding material between one weld and the next. The welding conditions and parameters for the production of a desired inflated cellular material depend on the feeding material used. According to one preferred embodiment when polyethylene 30 Microns is used as a feeding material the welding temperature can range between 100-250 C°, the welding time is 0.2-1 second and the preferred distance between every welding can be 20-100 millimeters.

The method of producing inflated cellular material 52 according to the present embodiment comprises a feeding step of which a pre-welded feeding material 62 is fed to the production line. The second step is conveying the feeding material in the opposite direction to the direction of the air flowing from air pipe inflator 66. The following step is the inflating of the feeding material. The inflating step is concurrently performed with the controlling step, thus, the inflation of feeding material is controlled by the first and or the second conveyor 58, 64. During this step the apparatus of the present invention controls the amount of air inserted into the feeding material through the use of a first and second conveyors. The distance between the first and second conveyor limits the amount of air that can enter the sleeves or rows of cells. The next step is the horizontal or horizontal and longitudinal welding step performed by the welding unit 54. Finally the ready to use inflated cellular material 52 is provided at the end of the production line. According to other embodiments a cutting machine can be attached to apparatus 50 that can provide different sizes of inflated cellular material 52. The cutting machine comprises a top and bottom sharp members which when moving together cut the inflated cellular material 52. The cutting machine would preferably be located at the end of the production line.

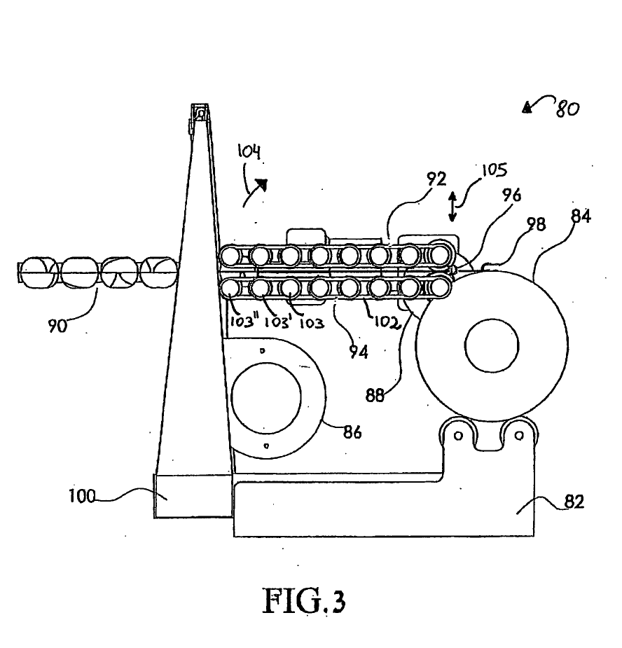

FIG. 3 provides a side view of the preferred embodiment according to the present invention. Apparatus 80 comprises a housing 100 that comprises the dispensing unit 82, a first conveyor 94, a second conveyor 92, a welding unit (not shown), a motor 88, an air pipe inflator 96 and a blower 86. Motor 88 is coupled to and drive belt 102 forward or backward. Belt 102 can also comprise single plastic units making up a chain like belt each plastic unit having a fixed length. Belt 102 can be a plastic or rubber or other flexible material belt preferably having protrusions which can fit depressions in the free rotating rollers. Rollers 103, 103′, 103″ are placed within a metal frame (mot shown) coupled to free hinges (not shown) allowing the free rotation of each roller. Each roller is preferably plastic coated. The plastic coating can have a rough surface thus assisting in the movement of the feeding material towards the end of the production line. Belt 102 is placed around the rollers such that it may provide forward or backward movement to the free rotating rollers. Rollers 103, 103′ 103″ and the like may have specific depressions to accept protrusions in belt 102 for precision and effective movement of all the rollers. The length between each conveyor 92, 94 may be adjusted in the up and down direction 105 so as to allow additional air to be inflated into the feeding material. Additionally, the conveyor 92 may be opened in the direction of arrow 104 thus allowing an operator of the apparatus 80 to resolve problems caused between the conveyers and for service purposes.

Feeding material roll 84 is positioned on dispensing unit 82 and provides the feeding material 98 to produce inflated cellular material 90. Blower 86 is positioned according to preferred embodiment above the feeding material 98, one conveyor 94 and a second conveyor 92. Apparatus 80 is shown in a side view and therefore the welding unit is not shown. Feeding material 98 can be a pre-welded material as depicted in view of FIG. 2. According to other embodiments the feeding material can be other types of pre-welded material such as depicted in co-filed PCT patent applications, titled AN IMPROVED CELLUAR CUSHIONED MATERIAL and INFLATED CELLULAR MATERIAL HAVING A BRICK LINE FORMATION, both by Matarasso filed on 4 Jun. 2003.

Feeding material 98 is inflated with air supplied from air pipe inflator 96. Air pipe inflator 96 is connected to blower 86. Blower 86, motor 88 and conveyors 92 and 94 can be the same as depicted in view of FIG. 2. Second conveyor 92 conveys feeding material 98 to the welding unit, the can be according to one embodiment the same as depicted in view of FIG. 2. The first conveyor 94 controls the amount of air inflated to feeding material 98 by air pipe inflator 96. The inflated cellular material 90 received is flat and not deformed as a result of the controlling step performed by the one conveyor 94.

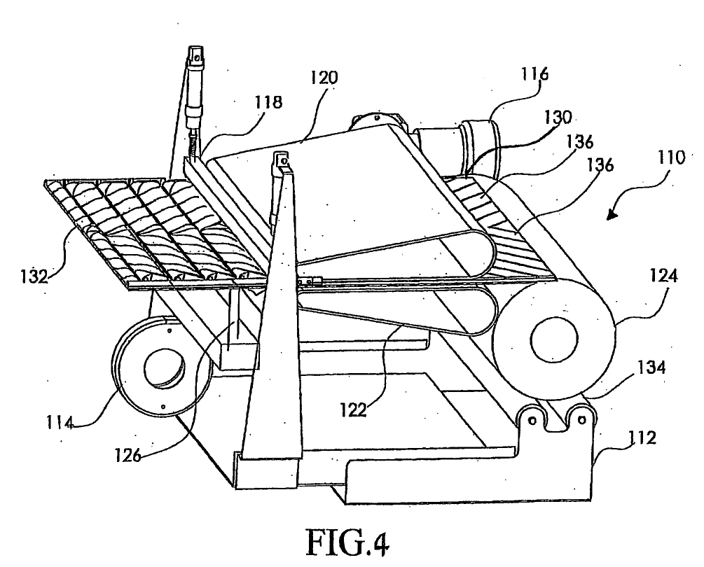

FIG. 4 presents a second embodiment of an apparatus according to the present invention. Apparatus 110 comprises a housing 112 that comprises the dispensing unit 134, a belt conveyor 120, a belt conveyor 122, a welding unit 118, a motor 116, an air pipe inflator 126 and a blower 114. Feeding material roll 124 is positioned on dispensing unit 134 and provides the feeding material 130 to produce inflated cellular material 132. Blower 114 is positioned according to preferred embodiment beneath the welding unit 118. The air pipe inflator 126 is positioned on the side of the feeding material 130. Accordingly, the pre-welded sleeves or rows of cells 136 are aligned towards the air pipe inflator 126 as depicted in view of FIG. 2 only from one side. Similarly, to the operating function performed by the conveyors, as depicted in view of FIGS. 2 and 3, is performed by the belt conveyors 120 and 122 in apparatus 110. Belt conveyors 120, 122 comprise a belt having a width of the horizontal span of the apparatus. Belt conveyors 120 and 122 are connected to and activated by motor 116 in a manner known in the art. The belt may be a flexible material or a material made of plastic units, such that when moving the feeding material inflated and in contact with the belt conveyor inner face will be assisted by the movement of the belt. The operating characteristics depicted in view of FIG. 2 are applicable to the present preferred embodiment. Belt conveyor 122 conveys feeding material 130 towards air pipe inflator 126, welding unit 118 and extracts from apparatus 110 the inflated cellular material 132. The inflation of air to feeding material is performed at the air pipe inflator outlet 128. Belt conveyor 120 is positioned above and belt conveyor 122 is positioned below the inflated surface of feeding material 130 and controls the amount of inflated air inserted to the pre-welded sleeves or rows of cells 136. According to another embodiment the air pipe inflator can be positioned in the center of the feeding material providing a similar configuration of apparatus and pre-welded material as depicted in view of FIG. 2. Thus, in such an embodiment the belt conveyors can be split conveyors and can substitute the conveyors.

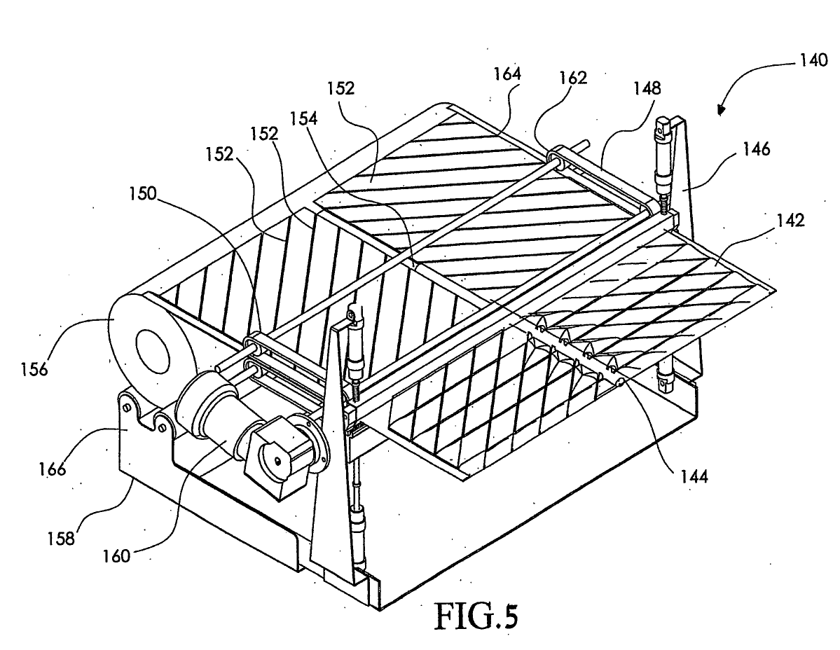

FIG. 5 presents a third embodiment of an apparatus according to the present invention. Apparatus 140 comprises a housing 158 that comprises the dispensing unit 166, a first belt conveyor 148, a second belt conveyor 150, a third belt conveyor (not shown), a welding unit 146, a motor 160, an air pipe inflator 154 and a blower (not shown). Similar to the embodiments depicted above feeding material roll 156 is positioned on dispensing unit 166 and provides feeding material 164 input to produce inflated cellular material 142 output. Feeding material 164 is conveyed by a conveyor (not shown in FIG. 5) positioned beneath feeding material 164 towards air pipe inflator's 154 outlet and welding unit 146. Arrow 168 indicates the movement direction of feeding material according to the present preferred embodiment. As in the above embodiments various types of feeding materials can be used. According to one embodiment a pre-welded material with sleeves or rows of cells 152 is used. Motor 160 is connected and activates the conveyor beneath (not shown) as well as the first and second belt conveyors 148 and 150. First and second belt conveyors 148 and 150 control the amount of air inflated to feeding material 164 by air pipe inflator 154. The first and second belt conveyors 148 and 150 control the amount of air by preserving the position of the side edges of feeding material 164. As depicted above, to the prior art apparatuses failed to preserve the position of feeding material during the production of inflated cellular materials. As a result the inflation of air ended with a deformation of feeding materials and defects within the final material and halting of the production line. According to the present preferred embodiment another manner is disclosed that prevents deformation of feeding material.

First and second belt conveyors 148 and 150 are set to have a perimeter that preserves the position of feeding material. First and seconf conveyors can be about 5 to 50 millimeter in width, but can be wider or narrower. The distance between the rollers can be about 1 to 30 millimeter but can be wider or narrower. Thus, first and second belt conveyors 148 and 150 preserve the amount of air inflated to feeding material subject to the tightness of feeding material preserved by the conveyor belts. The controlling of the air amount within inflated feeding material is reached according to the preferred embodiment with rotating rod 162. Similarly, first and second belt conveyors 148 and 150 can be replaced by a conveyor with protrusions that are set to fit parallel apertures within side edges of feeding material.

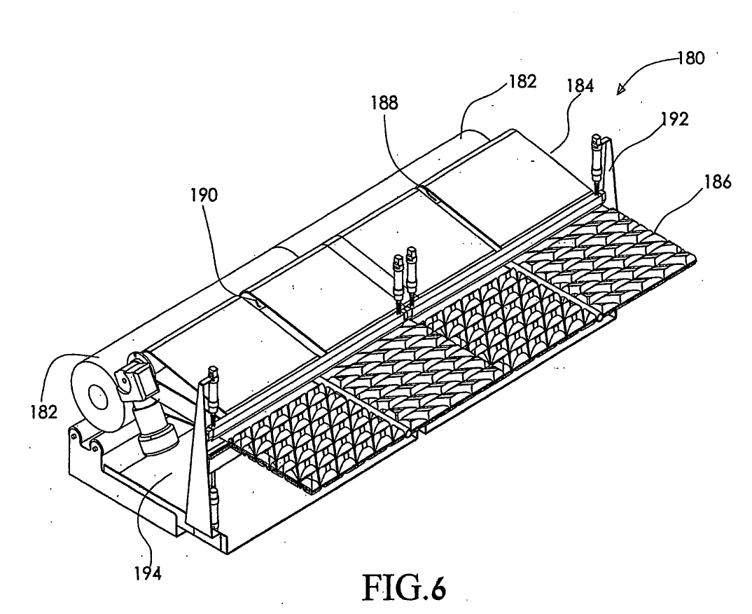

FIG. 6 presents a fourth preferred embodiment of an apparatus according to the present invention. According to the present embodiment apparatus 180 comprises similar components as the above depicted embodiments. Additionally, apparatus 180 includes two apparatuses as depicted above connected to one and comprising one apparatus. Apparatus 180 enables a single apparatus 180 to process a large amount of feeding material to be converted to be an inflated cellular material. Thus, increasing the capability to provide a mass production of inflated cellular material. Accordingly, apparatus 180 comprises a long feeding roll of material 182, four belt conveyors 184, two air pipe inflators 188 and 190, two welding units 192 and 194. Apparatus 180 can provide a large inflated cellular material 186 that is enables to wrap or protects a large item conveniently.

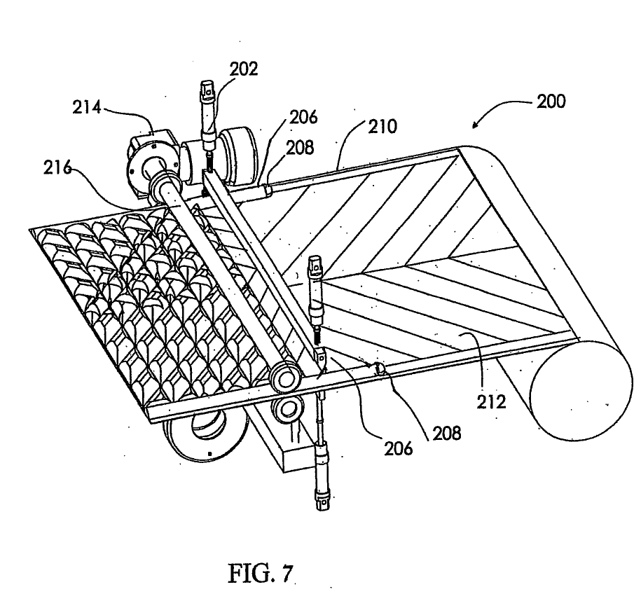

FIG. 7 presents a fifth embodiment of the present invention. According to the present embodiment apparatus 200 comprises similar components as the above depicted embodiments. Apparatus 200 differentiates from other embodiments by the location of the air pipe inflators 206 location and the air amount control within inflated cellular material 210. According to the preferred embodiment the plates 206 and 208 are located on the edges of inflated cellular material 204. Air pipe inflator(s) 210 inflate air to pre-welded sleeves or rows of cells 212. The air pipe inflator(s) 210 that are positioned at edge of inflated cellular material 204 hold inflated cellular material 204. In the present embodiment, the air pipe inflators are about 5 to 30 millimeter in diameter and about 1 to 25 centimeter in length but can be longer or shorter. Advancing wheels 204 that are connected to motor 214 perform the advancement of inflated cellular material 210. Advancing wheels 204 according to the preferred embodiment are connected with a pivot 216. According to the preferred embodiment air pipe inflators' outlet 208 inflates air to feeding cellular material 210.

The person skilled in the art will appreciate that what has been shown is not limited to the description above. Those skilled in the art to which this invention pertains will appreciate many modifications and other embodiments of the invention. It will be apparent that the present invention is not limited to the specific embodiments disclosed and those modifications and other embodiments are intended to be included within the scope of the invention. Although specific terms are employed herein, they are used in a generic and descriptive sense only and not for purposes of limitation.

1. An apparatus for the production of inflated cellular cushioning material, the apparatus comprising:
a dispensing unit comprising a feeding material roll, for feeding plastic material having sleeves or rows of cells, to be filled with air;
a first and second conveyors for receiving the feeding material and holding such feeding material in a substantially flat position confining feeding material inflation, between the first and second conveyors;
at least one motor for rolling the first and second conveyors;
at least one device for supplying air or gas for providing air or gas connected to an at least one air pipe inflator for directing the flow of air or gas into the feeding material; and
at least one welding unit for sealing the feeding material.

2. The apparatus of claim 1 wherein the first and second conveyors are used so as to control or limit the amount of air or gas inflated into the sleeves or rows of cells.

3. The apparatus of claim 1 wherein the at least one device for moving the conveyors such as a motor is used.

4. The apparatus of claim 1 wherein the at least one device for supplying air or gas is positioned so as to allow the inflation of the feeding materials.

5. The apparatus of claim 1 wherein the at least one device for supplying air or gas is a centrifugal blower.

6. The apparatus of claim 1 further comprising of specified distance between the first and second conveyors.

7. The apparatus of claim 1 wherein the first conveyor is mechanically situated such that the feeding material is received by the first and second conveyors so that when the feeding material is inflated, said material comes in contact with the first and second conveyors.

8. The apparatus of claim 1 wherein the first conveyor is positioned on one side of the feeding material while the second conveyor is positioned on the opposite side of the feeding material.

9. The apparatus of claim 1 wherein the welding unit is a heating bar unit controlled to reach high temperature in a predetermined time period allowing a short time interval contact with inflated feeding material.

10. The apparatus of claim 1 wherein the welding unit welds a horizontal line across the span of the feeding material.

11. The apparatus of claim 1 wherein the welding unit welds a short longitudinal line and a long horizontal line across the span of the feeding material.

12. The apparatus of claim 1 further comprising a cutting machine comprising a bottom and top cutting members for cutting the inflated cellular cushioning material at the end of the production line.

13. The apparatus of claim 1 wherein the length between each conveyor is adjustable in the up and down direction so as to allow additional air to be inflated into the feeding material.

14. The apparatus of claim 1 wherein the first conveyor may be opened for allowing an operator of the apparatus to feed the feeding material into the apparatus.

15. The apparatus of claim 1 wherein each of the first and second conveyors comprise rollers placed within a metal frame coupled to free hinges allowing the free rotation of each roller; a belt placed around the rollers such that the belt may provide forward or backward movement of the conveyors belt.

16. The apparatus of claim 1 wherein the first and second conveyors are belt conveyors.

17. The apparatus of claim 1 wherein the first and second conveyors are belt conveyors, each conveyor comprising a belt having a width sufficient to hold the position of the side edges of feeding material.

18. The apparatus of claim 1 further comprising a third and fourth conveyors for receiving the feeding material and holding such feeding material in a substantially flat position between the first and second conveyors.

19. The apparatus of claim 15 wherein the belt is a chain having a plurality of plastic units of fixed length.

20. The apparatus of claim 15 wherein the belt is made of a flexible material.

21. The apparatus of claim 15 wherein the conveyors are rollers or plates.

22. A method for the production of inflated cellular material, the method comprising the steps of:
feeding pre-welded feeding material to the apparatus;
conveying the feeding material in the opposite direction to the direction of the air flow from an air pipe inflator;
controlling the amount of air inserted into the feeding material through the use of a first and second conveyors;
applying at least one welding unit to the inflated feeding material, thus forming inflated cellular cushioning material.

23. The method of claim 22 further comprising the step of providing the ready to use inflated cellular material at the end of the production process.
